(19) United States
(12) Patent Application Publication
(10) Pub. No.: US 2009/0282941 A1
(43) Pub. Date: Nov. 19, 2009

(54) DRIVING SIMULATION DEVICE FOR SIMULATING A DRIVING GAME

(75) Inventors: LI-HSIEN CHANG, TAIPEI COUNTY (TW); CHI-SHIAN WANG, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: IGS INTERNATIONAL GAMES SYSTEM CO., LTD., TAIPEI COUNTY (TW)

(21) Appl. No.: 12/235,806

(22) Filed: Sep. 23, 2008

(30) Foreign Application Priority Data
May 14, 2008 (TW) 097208377

(51) Int. Cl. A63G 31/02; A63G 31/16; G09B 9/058

(52) U.S. Cl. 74/470; 273/442; 434/61; 472/59; 74/469

(57) ABSTRACT

A driving simulation device for simulating a driving game includes a mounting frame, a coupler shaft journaled to the mounting frame, extending along a coupling axis and cooperating with a horizontal direction to define an inclined acute angle, a seat body fixed on the coupler shaft above the mounting frame and having an extending direction, a seating portion and a driving portion disposed on the seat body along the extending direction. The extending direction of the seat body cooperates with the coupling axis to define a deviating acute angle therebetween. A swinging action of a rider on the seat body relative to the mounting frame results in turning of the seat body about the coupling axis, which, in turn, causes swinging action of the driving portion and the seating portion such that a swinging range of the driving portion is smaller than that of the seating portion.

This application claims the benefit of Taiwan Patent Application Serial No.097208377, filed May 14, 2008, the subject matter of which is incorporated herein by reference.

### FIELD OF THE INVENTION

The invention relates to a game device, more particularly to a driving simulation device for simulating a driving game, in which an inclined coupler shaft is utilized to allow a rider to simulate a driving action such that a swinging action of the rider during the driving operation causes a smaller swinging range of the rider' head by compared to the rider's body.

### BACKGROUND OF THE INVENTION

A conventional driving simulation device allows a player to simulate a real driving action. For instance, a motorcycle simulator includes a motorcycle-like apparatus to be driven by a rider so as to generate an operating signal that is transmitted to a processor for processing the signal in such a manner that a response thereof is displayed in a display device to thereby achieve the simulating effects.

Referring to FIG. 1, a game device for a motorcycle simulator 80 is shown to include a driver seat 81, a coupler shaft 82 and a mounting frame 83. The driver seat 81 is fixed on the coupler shaft 82, which, in turn, is journaled to the mounting frame 83. The coupler shaft 82 extends along a horizontal axis E1 so that, during simulating the driving operation, the rider can swing the driver seat 81 about the horizontal axis E1. The driver seat 81 defining an extending direction E2 has a seating portion 811 and a driving portion 812 along the extending direction. The driving portion 812 is located at a frontward of the seating portion 811. Since the extending direction E2 is parallel to the horizontal axis E1, once the rider is seated on the seating portion 811 for a ride, the rider's head is located adjacent to the driving portion 812. During the driving operation, the rider generally swings his/her body for turning the road by changing gravity center of the body.

Note that the extending direction E2 of the driver seat 81 is parallel to the horizontal axis E1. During the driving operation, frequent swinging actions of the rider from his/her maneuvering upon the simulator may discomfort the rider's head as well as his/her body after a period of time. In addition, since the swinging range of the rider's head may be too large to be completely limited within the range of the display screen, the rider may need to constrain his/her head in order to view the display screen, and thereby further discomfort may rise to the rider. Moreover, even the leftward-and-rightward swinging of the driver seat 81 can be simulated, the actual driver's view which directs to the turning direction cannot be precisely captured by the simulator whose display screen is always kept in the front side of the simulator. Namely, difficulty in simulating the driving action to generate a quasi-driving movement is still there.

### SUMMARY OF THE INVENTION

The object of the present invention is to provide a driving simulation device for simulating a driving game, which permits a rider to sit thereon for simulating a motorcycle driving action such that swinging action of the rider during the driving operation causes a smaller swinging range of the rider's head by compared to the rider's body.

A driving simulation device according to the present invention includes a mounting frame, a coupler shaft journaled to the mounting frame and extending along a coupling axis and cooperating with a horizontal direction to define an inclined acute angle, a seat body fixed on the coupler shaft so as to be disposed above the mounting frame, the seat body having an extending direction, a seating portion and a driving portion disposed on the seat body along the extending direction, in which the extending direction cooperating with the coupling axis defines a deviating acute angle therebetween. A swinging action of a rider on the seat body relative to the mounting frame results in turning of the seat body about the coupling axis, which, in turn, causes a respective swinging action of the driving portion and the seating portion such that a swinging range of the driving portion is smaller than that of the seating portion.

The driving simulation device of the present invention provides the following advantages.

I. The swinging range of the driving portion is smaller than that of the seating portion. Thus, during the driving operation to simulate a motorcycle riding, the body of the rider will swing violently relative to the mounting frame. However, since the rider's head is located near the driving portion, the rider's head is prevented from violent swinging so that only minor discomfort may be caused to the rider's head.

II. The rider needs not turn his head sidewise as violently as the seat body since the rider's view falls within the viewing range of the display screen so that, during turning of the motorcycle simulator, the rider can directly see the display screen disposed frontwardly thereof without turning the head, and thereby a better driving simulation effect can be obtained.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a side view of a conventional motorcycle simulator;

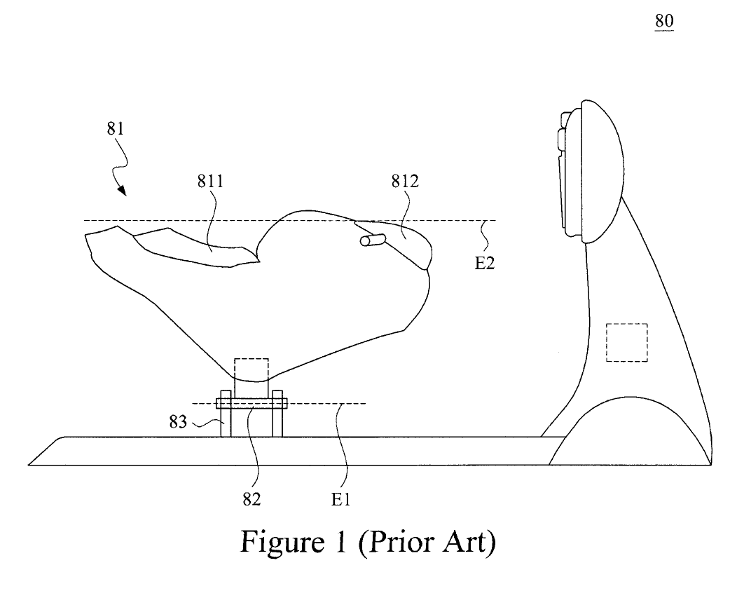

FIG. 2 is a side view of a driving simulation device of the present invention;

FIG. 3 shows a block diagram illustrating components constituting the driving simulation device of the present invention;

FIG. 4 is a partial perspective view of the driving simulation device of the present invention;

FIG. 5 is a partial side view of the driving simulation device of the present invention;

FIG. 6 is an exploded view of a position restoration mechanism employed in the driving simulation device of the present invention;

FIG. 7 is a cross-sectional view of an assembled position restoration mechanism employed in the driving simulation device of the present invention;

FIG. 8 is a first perspective view of the driving simulation device of the present invention during the driving simulating action; and

FIG. 9 is a second perspective view of the driving simulation device of the present invention during the driving simulating action.

### DETAILED DESCRIPTION OF THE PREFERRED EMBODIMENT

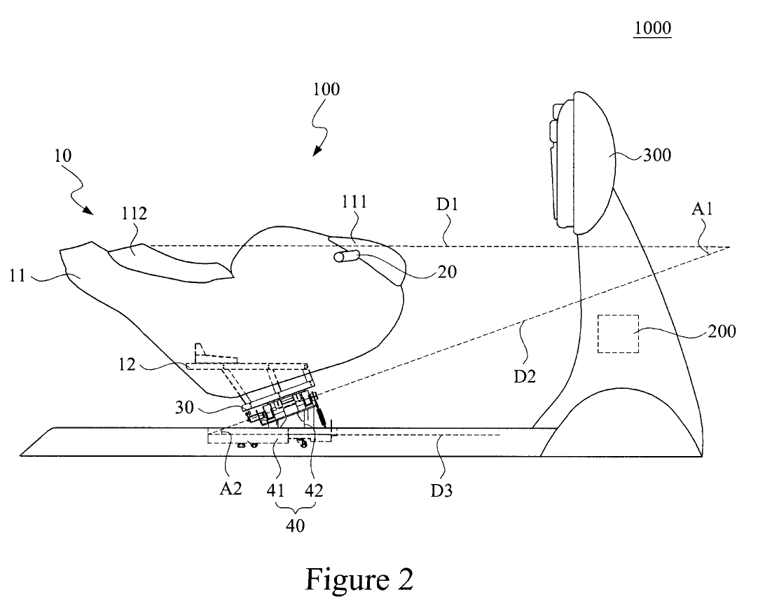

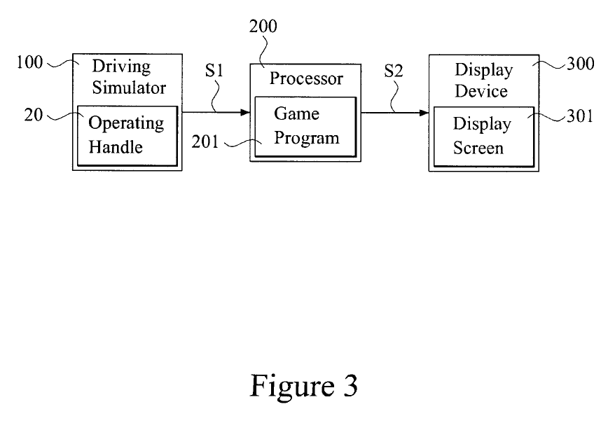

Referring to FIGS. 2 and 3, wherein FIG. 2 is a side view of a driving simulation device 1000 for simulating a driving game of the present invention and FIG. 3 shows a block diagram illustrating components constituting the driving simulation device 1000 of the present invention. The driving simulation device 1000 accordingly includes a driving simulator 100, a processor 200 and a display device 300.

The driving simulator 100 is used for simulating a motorcycle driving action, and permits seating of a rider thereon. Swinging actions of the rider's body will directly result in swinging of the driving simulator 100.

The driving simulator 100 includes a seat body 10, an operating handle 20, a coupler shaft 30 and a mounting frame 40. The seat body 10 includes a carrier frame 12 having a bottom part fixed on the coupler shaft 30 and an outer shell 11 mounted on and enclosing the carrier frame 12 therewithin. The outer shell 11 may have the profile of a motorcycle or any other structure depending on the purpose of the simulation game device. The seat body 10 defines longitudinally an extending direction D1, and has along the extending direction D1 a seating portion 112 and a driving portion 111 disposed on the seat body 10 along the extending direction D1 so as to be proximate to the display device 300. The seating portion 112 is provided to permit seating of the rider (not shown). The operating handle 20 is attached to the driving portion 111 so as to permit the rider to grip thereon for simulating a driving action.

The coupler shaft 30 journaled to the mounting frame 40 extends along a coupling axis D2 and cooperates with the extending direction D1 to define a deviating acute angle A1 therebetween. The swinging action of the rider on the seat body 10 results in turning of the seat body 10 about the coupling axis D2.

The mounting frame 40 includes a bottom base 41 and a holding frame 42. The bottom base 41 extends along the horizontal direction D3 that cooperates with the coupler axis D2 to define the inclined acute angle A2. The horizontal direction D3 can be strictly disposed parallel to the water level (not shown). The holding frame 42 is disposed above the bottom base 41. In this embodiment, the coupler shaft 30 is journaled to the holding frame 42.

The operating handle 20 in fact is a motorcycle handle for operating the motorcycle simulator 100. The operating handle 20 and the motorcycle simulator 100 are coupled electrically to the processor 200 such that when the rider operates the handle 20 or swings the motorcycle simulator 100, an operation signal SI is generated and transmitted to the processor 200 for undergoing a procession.

The processor 200 can process a game program 201 and the signal S1 in such a manner to result in a display signal S2 (see FIG. 3). The display signal S2 is displayed in a display screen 301 of the display device 300 upon receipt thereof.

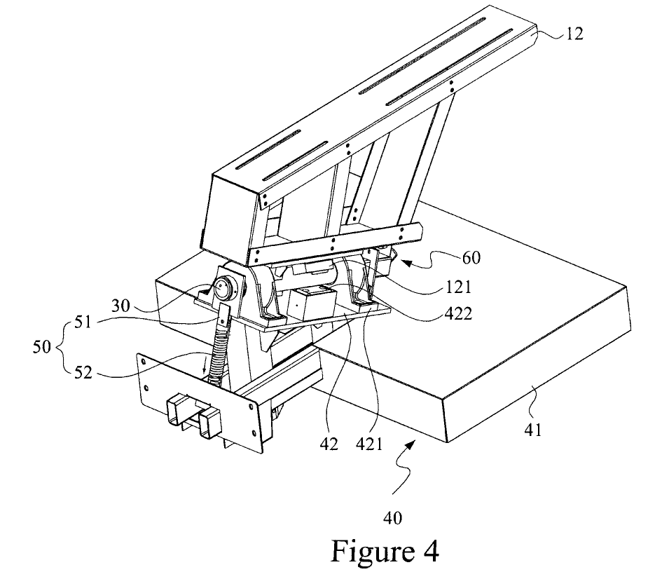

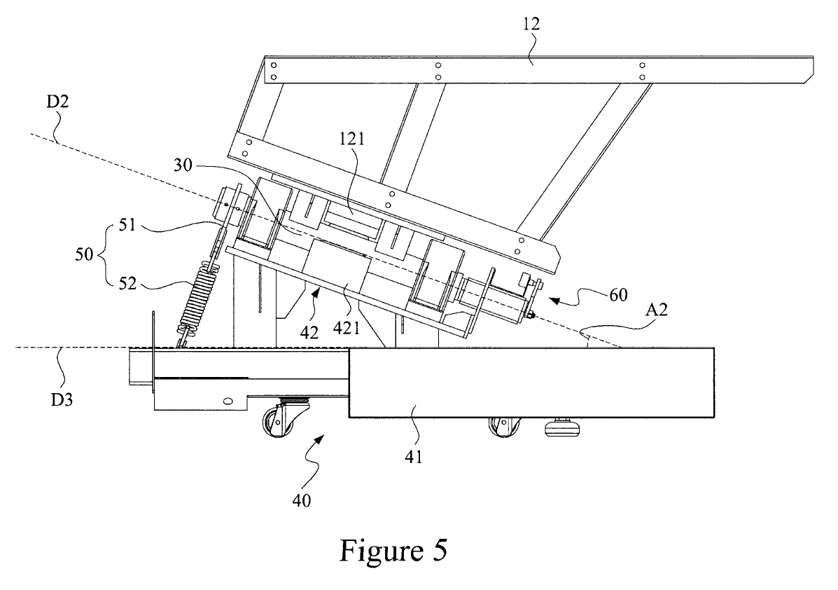

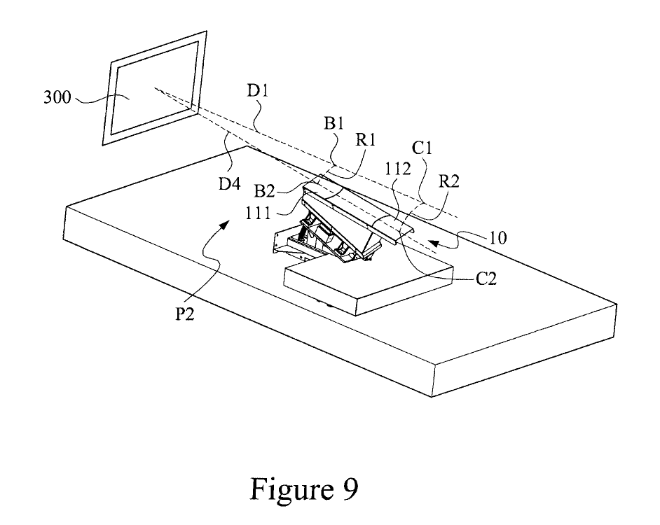

Referring to FIGS. 4 and 5, wherein FIG. 4 is a partial perspective view of the driving simulation device of the present invention and FIG. 5 is a partial side view of the driving simulation device of the present invention. The holding frame 42 further has a lower stop member 422. The carrier frame 12 of the seat body 10 is provided with an upper stop member 121 that is disposed above the lower stop member 422 and that is adapted to collide against the lower stop member 422 in case the seat body 10 is turned about the coupling axis D2, and thereby the greatest turning range P2 of the seat body 10 relative to the mounting frame 40 can be limited (see FIG. 9). The holding frame 42 has a bearing unit 421 to permit journalling of the coupler shaft 30 thereto since the coupling shaft 30 is mounted on the mounting frame 40 in an inclined position. When the bearing unit 421 is thus arranged, the coupler shaft 30 can rotate smoothly about the coupling axis D2. Since the structure of the bearing unit 421 is known in the art, a detailed description thereof is omitted herein for the sake of brevity.

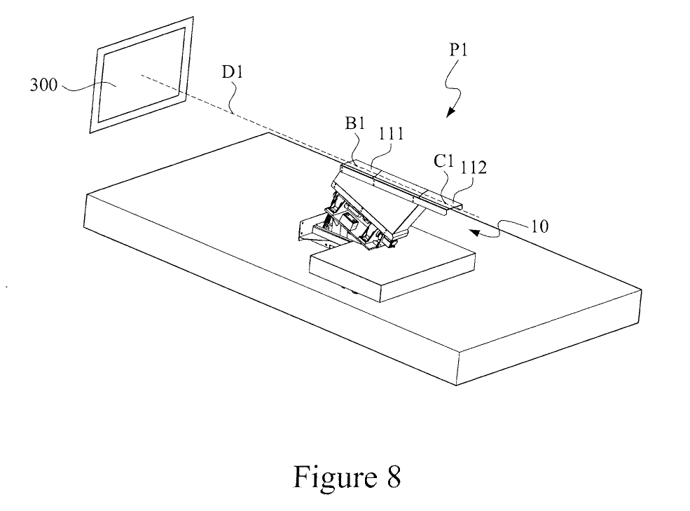

The driving simulation device of the present invention further includes a pull mechanism 50 for restoring the seat body 10 to its initial position P1 (see FIG. 8). The pull mechanism 50 includes a fixing element 51 and a spring member 52. The fixing element 51 holds one end of the coupler shaft 30 rotatably therein since the other end is mounted rotatably in the bearing unit 421. The spring member 52 interconnects the fixing element 51 and the bottom base 41 of the mounting frame 40 in such a manner that, in case an assembly of the seat body 10 and the coupler shaft 30 is turned about the coupling axis D2, the spring member 52 exerts a pulling force on the fixing element 51 so as to restore the seat body 10 to the initial position.

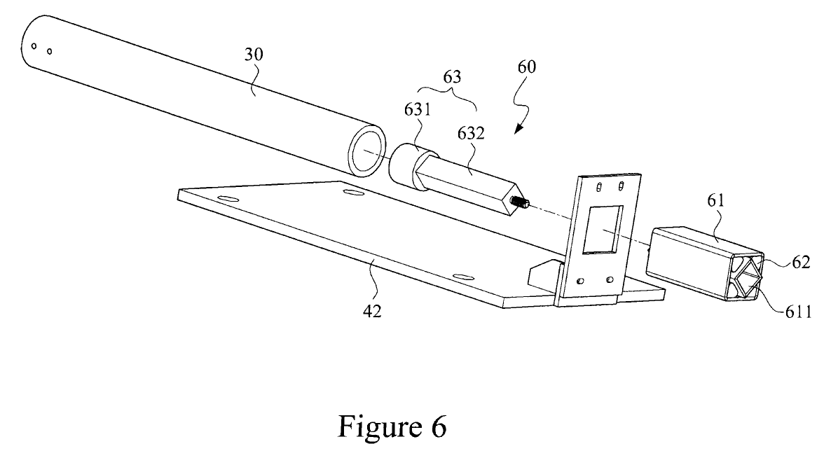

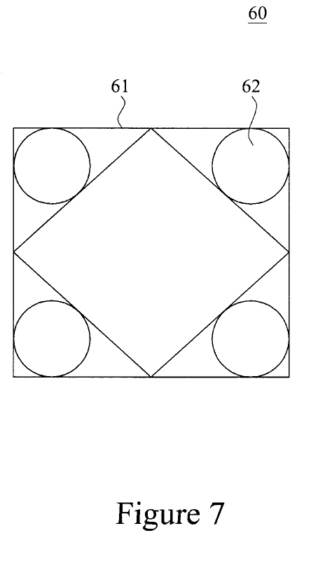

The driving simulation device of the present invention further includes a position restoration mechanism 60 for restoring the seat body 10 to its initial position P1 (see FIG. 8). Referring to FIGS. 6 and 7, the position restoration mechanism 60 includes a limited member 61, a plurality of resilient elements 62 and a retrieving member 63. The limited member 61 is fixed to the holding frame 42. The limited member 61 is a polygonal casing having an inner wall 611. The resilient elements 62 (generally springs) are distributed in the polygonal casing 61 at the corners thereof so as to be in touch with the inner wall 611. The retrieving member 63 has a first coupling end 631 fixed the coupler shaft 30 and a second coupling end 632 of a polygonal cross section extending into the polygonal casing 61 so as to be in touch with the resilient elements 62. Under this condition, turning an assembly of the retrieving member 63 and the coupler shaft 30 about the coupling axis D2 results in a pressing action onto the resilient elements 62 such that the resilient elements 62 possess a restoration force for pushing back the seat body 10 to its initial position P1 since the seat body 10 is fixed on the coupler shaft 30.

FIGS. 8 and 9 respectively show first and second perspective views of the driving simulation device of the present invention during the driving simulating action when the rider swings the seat body 10.

As illustrated in FIG. 8, the seat body 10 is at its initial position P1, wherein the driving portion 111 is located at an initial position B1 while the seating portion 112 is located at an initial position C1. At this time, the initial positions B1 and C1 extend along the extending direction D1 of the seat body 10 such that, once the rider is seated on the seating portion 112 for simulating a motorcycle riding action, his/her head will be located near the driving portion 111. The viewing angle of the rider is along the D1 direction, and thus falls within the range of the display device 300.

Referring to FIG. 9, in case the seat body 10 is swung to the largest angle P2 due to a swinging action of the rider's body, the driving portion 111 is moved from the initial position B1 to another position B2 while the seat portion 112 is moved from the initial position C1 to another position C2. In other words, an extending line D4 formed by the points (positions) B2 and C2 deviates from the extending direction D1. From the drawing, it can be observed that the moving range R1 of the driving portion 111 is smaller than the moving range R2 of the seating portion 112. Thus, after seating on the seating portion and when the rider swings his body violently for turning so as to simulate the motorcycle driving action, his/her head is prevented from swinging as violently as his/her body. Thus no additional discomfort is caused to the rider's head.

Since the extending line D4 formed by the points B2 and C2 is relatively close to the extending direction D1 of the seat body 10, the swinging range is still within the viewing range of the display device 300. Therefore, when the seat body 10 swings reciprocally and violently about the coupling axis D2, the rider' head turns a smaller degree with respect to the rider' body. Under such an arrangement, the rider's head is still looking at the display screen disposed frontwardly of the seat body 10 without turning the head while in simulating the motorcycle turning action.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A driving simulation device for simulating a driving game, comprising:
a mounting frame;
a coupler shaft journaled to said mounting frame, extending along a coupling axis and cooperating with a horizontal direction to define an inclined acute angle;
a seat body fixed on said coupler shaft so as to be disposed above said mounting frame, said seat body having an extending direction, a seating portion and a driving portion disposed on said seat body along said extending direction, said extending direction cooperating with said coupling axis to define a deviating acute angle therebetween;
wherein, a swinging action of a rider on said seat body relative to said mounting frame results in respective turning of said seat body about said coupling axis, which, in turn, causes a corresponding swinging action of said driving portion and said seating portion such that a swinging range of said driving portion is smaller than that of said seating portion.

2. The driving simulation device according to claim 1, wherein said seating portion is provided for a rider to be seated while said driving portion permits the rider to hold thereon for simulating a driving action.

3. The driving simulation device according to claim 1, wherein said seat body includes a carrier frame fixed on said coupler shaft and an outer shell mounted on and enclosing said carrier frame therewithin.

4. The driving simulation device according to claim 1, wherein said mounting frame includes:
a bottom base extending along the horizontal direction and cooperating with the coupler axis to define the inclined acute angle, and
a holding frame disposed above said bottom base, said coupler shaft being journaled to said holding frame.

5. The driving simulation device according to claim 4, wherein said holding frame has a bearing unit to permit journaling of said coupler shaft thereabout.

6. The driving simulation device according to claim 1, further comprising a pull mechanism for restoring said seat body to its initial position, said pull mechanism including:
a fixing element for holding said coupler shaft rotatably therein; and
a spring member interconnecting said fixing element and said mounting frame;
wherein, in case an assembly of said seat body and said coupler shaft is turned about said coupling axis, said spring member exerts a pulling force on said fixing element so as to restore said seat body to the initial position.

7. The driving simulation device according to claim 1, further comprising a position restoration mechanism for restoring said seat body to its initial position, said position restoration mechanism including:
a limited member fixed to said mounting frame, said limited member being a polygonal casing having an inner wall;
a plurality of resilient elements distributed in said polygonal casing so as to be in touch with said inner wall; and
a retrieving member of a polygonal cross section having a first coupling end fixed said coupler shaft and a second coupling end extending into said polygonal casing so as to be in touch with said resilient elements;
wherein turning of an assembly of said retrieving member and said coupler shaft about said coupling axis results in a pressing action onto said resilient elements such that said resilient elements possess a restoration force for pushing back said seat body to its initial position.

8. The driving simulation device according to claim 1, wherein said mounting frame further has a lower stop member, said seat body further having an upper stop member that is disposed above said lower stop member and that is adapted to collide against said lower stop member in case said seat body is turned about said coupling axis, thereby a greatest turning range of said seat body relative to said mounting frame being limited.

9. The driving simulation device according to claim 1, further comprising an operating handle attached to said driving portion so as to permit said rider to grip thereon for simulating a driving action.
